(19) United States
(12) Patent Application Publication
(10) Pub. No.: US 2025/0300275 A1
(43) Pub. Date: Sep. 25, 2025

(54) SECONDARY BATTERY

(71) Applicant: Standard Energy Inc., Daejeon (KR)

(72) Inventors: Dongyoung Lee, Seoul (KR); Bugi Kim, Sejong (KR)

(21) Appl. No.: 18/859,117

(22) PCT Filed: Apr. 21, 2023
(86) PCT No.: PCT/KR2023/005477

§ 371 Date: Oct. 22, 2024

(30) Foreign Application Priority Data
Apr. 22, 2022 (KR) 10-2022-0049958
May 9, 2022 (KR) 10-2022-0056788

(51) Int. Cl. H01M 10/6569; B60R 16/033; H01M 10/613; H01M 10/615; H01M 10/625; H01M 10/658; H01M 10/663; H01M 50/204; H01M 50/258

(52) U.S. Cl. CPC H01M 10/6569; H01M 10/613; H01M 10/615; H01M 10/625; H01M 10/658; H01M 10/663; H01M 50/204; H01M 50/258; B60R 16/033; H01M 2220/10; H01M 2220/20

(57) ABSTRACT

The present invention relates to a secondary battery which is charged and discharged by oxidizing and reducing metal ions dissolved in an electrolyte. The secondary battery according to an embodiment of the present invention includes: a plurality of secondary battery modules; a container accommodating the plurality of secondary battery modules therein; and an air-conditioning unit disposed on the plurality of secondary battery modules to cool, heat, or ventilate the plurality of secondary battery modules.

### FIELD

The present disclosure relates to a secondary battery. More specifically, the present disclosure relates to a secondary battery in which metal ions dissolved in an electrolyte are oxidized and reduced to charge and discharge the secondary battery.

### DESCRIPTION OF RELATED ART

A redox secondary battery is a system in which an active material in the electrolyte is oxidized and reduced to charge and discharge the battery and is an electrochemical storage device that stores electrical energy as the chemical energy of an electrolyte solution. A conventional redox flow battery operates by continuously circulating the electrolyte in a tank inside a stack using a pump and causing an electrochemical reaction in the stack. The redox flow battery has a space limitation and a design difficulty due to the tank and the pump. Inventors of the present disclosure have developed a redox secondary battery free of the tank and the pump. However, due to low energy density of the redox secondary battery free of the tank and the pump, volume and weight thereof should be increased. Thus, high-density integration thereof is required to minimize size and weight of the secondary battery, and thus, proper air-conditioning for cooling thereof is required depending on the high-density integration.

### DISCLOSURE

### Technical Purpose

A purpose of the present disclosure is to provide an air-conditioning structure capable of appropriately cooling a secondary battery in which secondary battery modules are integrated with each other at a high density.

The purposes of the present disclosure are not limited to the purposes mentioned above, and other purposes not mentioned may be clearly understood by those skilled in the art from the description as set forth below.

### Technical Solution

In order to achieve the purpose of the present disclosure, a secondary battery according to an embodiment of the present disclosure includes a plurality of secondary battery modules; a container accommodating the plurality of secondary battery modules therein; and an air-conditioning unit disposed on the plurality of secondary battery modules to cool, heat, or ventilate the plurality of secondary battery modules.

Details of other embodiments are included in the detailed description and drawings.

### Technical Effect

According to the secondary battery of the present disclosure, one or more of the following effects may be achieved,

First, when the secondary battery modules are integrated with each other, the air-conditioning unit may be disposed on the arrangement of the plurality of secondary battery modules.

Second, the air-conditioning unit disposed on the arrangement of the plurality of secondary battery modules may appropriately cool the plurality of secondary battery modules.

Third, even when the air-conditioning unit is disposed in the service module outside the container, the secondary battery module may be properly cooled through the air-conditioning unit.

The effects of the present disclosure are not limited to the effects mentioned above, and other effects not mentioned may be clearly understood by those skilled in the art from the description of the claims.

### BRIEF DESCRIPTION OF THE DRAWINGS

FIG. 1 is an exploded perspective view of a layer of a secondary battery according to an embodiment of the present disclosure.

FIG. 2 is a cross-sectional view of a layer of a secondary battery according to an embodiment of the present disclosure.

FIG. 3 and FIG. 4 are perspective views of a secondary battery module according to an embodiment of the present disclosure.

FIG. 5 is a partial perspective view of a secondary battery module according to an embodiment of the present disclosure.

FIG. 6 is a partial cross-sectional view of a secondary battery module according to an embodiment of the present disclosure.

FIG. 7 is a partial cross-sectional view of a secondary battery module according to another embodiment of the present disclosure.

FIG. 8 is a view illustrating a schematic configuration of a secondary battery according to an embodiment of the present disclosure.

FIG. 9 is an example view showing that a secondary battery according to an embodiment of the present disclosure is transported by transportation means.

FIGS. 10 to 12 are views illustrating various examples of an air-conditioning unit of a secondary battery according to an embodiment of the present disclosure.

FIGS. 10 to 16 are views illustrating various examples of an air-conditioning unit of a secondary battery according to an embodiment of the present disclosure.

FIGS. 17 and 18 are views illustrating a schematic configuration of a secondary battery according to another embodiment of the present disclosure.

FIG. 19 is an example view showing that a secondary battery according to another embodiment of the present disclosure is transported by transportation means.

FIG. 20 is a view illustrating a schematic configuration of a secondary battery according to still another embodiment of the present disclosure.

### DETAILED DESCRIPTIONS

The above-mentioned purposes, features, and advantages will be described in detail later with reference to the attached drawings, so that those skilled in the art in the technical field to which the present disclosure belongs may easily practice the technical ideas of the present disclosure. In describing the present disclosure, when it is determined that a detailed description of the publicly known technology related to the present disclosure may unnecessarily obscure the gist of the present disclosure, the detailed description thereof will be omitted. Hereinafter, a preferred embodiment according to the present disclosure will be described in detail with reference to the attached drawings. In the drawings, identical reference numerals are used to indicate identical or similar components.

Although first, second, and the like are used to describe various components, these components are not limited by such terms. Such terms are only used to distinguish one component from another component, and unless specifically stated to the contrary, a first component may also be a second component.

As used herein, the singular constitutes “a” and “an” are intended to include the plural constitutes as well, unless the context clearly indicates otherwise.

Hereinafter, it may mean that when a first component is described to be disposed “on (or under)” a second component, the first component may not only be disposed in contact with a top surface (or a bottom surface) of the second component, but also be disposed on the second component with a third component interposed therebetween.

Additionally, it should be understood that when a component is described as being “connected to”, “combined to”, or “coupled to” another component, the components may be directly connected or coupled to each other, but other components may be “interposed” therebetween and the components may be “connected to”, “combined to”, or “connected to” each other via said other components.

As used herein, singular expressions include plural expressions, unless the context clearly dictates otherwise. In the present application, terms such as “composed of” or “include” should not be construed as necessarily including all of various components or steps described herein and should be interpreted as being able to not include some of the components or the steps and further including additional components or steps.

Throughout the present disclosure, “A and/or B” means A, B, or A and B, unless otherwise specified, and “C to D” means C inclusive to D inclusive unless otherwise specified.

Hereinafter, the present disclosure will be described with reference to drawings for illustrating the secondary battery according to embodiments of the present disclosure.

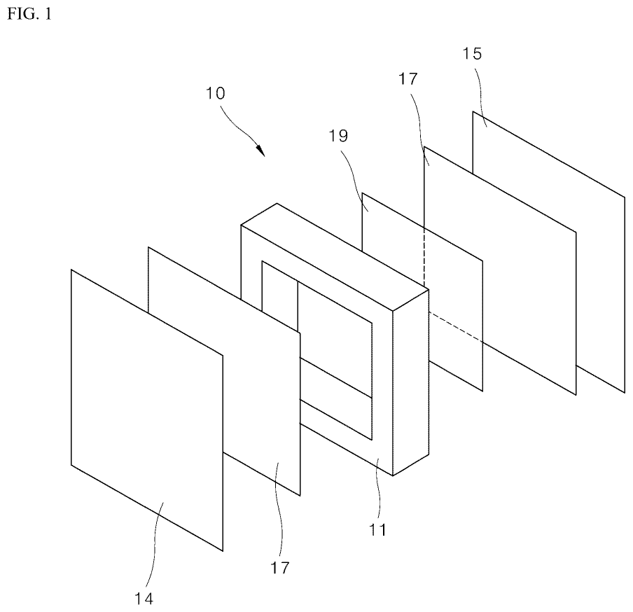

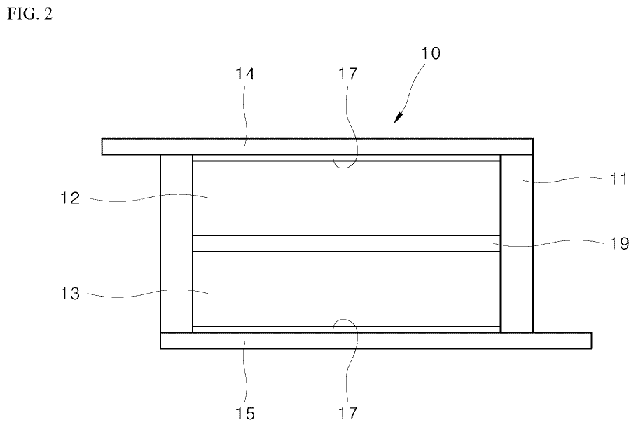

FIG. 1 is an exploded perspective view of a layer of a secondary battery according to an embodiment of the present disclosure, and FIG. 2 is a cross-sectional view of a layer of a secondary battery according to an embodiment of the present disclosure.

A layer 10 according to an embodiment of the present disclosure accumulates therein or releases therefrom electrical energy via a redox reaction of a redox couple dissolved in electrolyte. The layer 10 is a rectangular parallelepiped shape with a small height.

The layer 10 according to an embodiment of the present disclosure comprises an anode 12 where a first half reaction occurs, a cathode 13 where a second half reaction occurs, a separator 19 which separates the anode 12 and the cathode 13 from each other, a frame 11 that is divided into two spaces via the separator which accommodate the anode 12 and the cathode 13, respectively, an anode current collector 14 that is electrically connected to the anode 12, and a cathode current collector 15 that is electrically connected to the cathode 13.

The anode 12 contains an electrolyte in which the anode redox couple is dissolved and may further contain a conductive material such as carbon felt. The anode redox couple may comprises at least one of vanadium (V), zinc (Zn), bromine (Br), chromium (Cr), manganese (Mn), titanium (Ti), iron (Fe), cerium (Ce), and cobalt (Co). In this embodiment, the anode redox couple is a V²⁺/V³⁺ redox couple. The electrolyte may be an acidic aqueous solution as a solution which conducts electric current via ionization. Preferably, the acidic aqueous solution comprises sulfuric acid. In this embodiment, the electrolyte may be prepared by dissolving VOSO₄ (vanadylsulfate) or V₂O₅ (vanadium pentoxide) in H₂SO₄ aqueous solution.

In the anode 12, the first half reaction occurs. The first half reaction is as follows:

V²⁺←→V³⁺+e⁻

where → represents a discharge reaction direction and ← represents a charge reaction direction. In a discharging operation, vanadium ions are oxidized to vanadium trivalent ions. In a charging operation, vanadium trivalent ions are reduced to vanadium divalent ions.

The anode 12 may further contain a solid electrode made of a carbon-based material such as carbon or graphite felt, carbon cloth, carbon black, graphite powder, or graphene. The solid electrode may be formed in a porous rectangular shape and may be impregnated with an electrolyte or mixed with the electrolyte in a form of powder, felt, fillet, etc.

The anode 12 is surrounded with the frame 11, the anode current collector 14 (or a bipolar plate 17), and the separator 19. The anode 12 is electrically connected to the anode current collector 14. Thus, when the battery is discharged, electrons migrate from the anode 12 to the anode current collector 14, whereas when the battery is charged, electrons from the anode current collector 14 migrate to the anode 12. The anode 12 is in contact with the separator 19, such that hydrogen cations (protons) are transferred through the separator 19.

The cathode 13 contains an electrolyte in which a cathode redox couple is dissolved and may further contain a conductive material such as carbon felt. The cathode redox couple may comprises at least one of vanadium (V), zinc (Zn), bromine (Br), chromium (Cr), manganese (Mn), titanium (Ti), iron (Fe), cerium (Ce), and cobalt (Co). In this embodiment, the cathode redox couple is a V⁴⁺/V⁵⁺ redox couple. The electrolyte may be an acidic aqueous solution as a solution which conducts electric current via ionization. Preferably, the acidic aqueous solution comprises sulfuric acid. In this embodiment, the electrolyte may be prepared by dissolving VOSO₄ (vanadylsulfate) or V₂O₅ (vanadium pentoxide) in H₂SO₄ aqueous solution.

In the cathode, the second half reaction occurs. The second half reaction is as follows:

V⁵⁺+e⁻←→V⁴⁺

where → represents a discharge reaction direction and ← represents a charge reaction direction. In a discharging operation, vanadium pentavalent ions are reduced to vanadium tetravalent ions. In a charging operation, vanadium tetravalent ions are oxidized to vanadium pentavalent ions.

The cathode 13 may further contain a solid electrode made of a carbon-based material such as carbon or graphite felt, carbon cloth, carbon black, graphite powder, or graphene. The solid electrode may be formed in a porous rectangular shape and may be impregnated with an electrolyte or mixed with the electrolyte in a form of powder, felt, fillet, etc.

The cathode 13 is surrounded with the frame 11, the cathode current collector 15 (or the bipolar plate 17), and the separator 19. The cathode 13 is electrically connected to the cathode current collector 15. Thus, when the battery is charged, electrons migrate from the cathode to the cathode current collector 15, whereas when the battery is discharged, electrons from the cathode current collector 15 migrate to the cathode 13. The cathode 13 is in contact with the separator 19, such that hydrogen cations (protons) are transferred through the separator 19.

Referring to FIG. 2, the anode 12 and the cathode 13 are arranged vertically. In one layer 10, the anode 12 may be disposed on the separator and the cathode 13 may be disposed beneath the separator. Alternatively, the cathode 13 may be disposed on the separator, and the anode 12 may be disposed beneath the separator.

The frame 11 is formed as a hollow hexahedron. The frame 110 preferably has a rectangular parallelepiped shape with a small height with open top and bottom surfaces. According to an embodiment, the frame 110 may be formed as a polyhedron of various shapes. The frame 11 is a hollow space that is divided into two spaces via the separator 19. The frame 11 supports the separator 19.

The separator 19 is disposed in the inner space of the frame 11 to separate the anode 12 and the cathode 13 from each other and allows hydrogen cations (protons) to migrate between the anode 12 and the cathode 13 therethrough. The separator 19 is disposed in the hollow space of the frame 11 to divide the hollow space into two spaces where the anode 12 and the cathode 13 are accommodated, respectively. The separator 19 is disposed between the anode current collector 14 and the cathode current collector 15. An edge of the separator 19 is coupled to the frame 11. Hydrogen cations migrate from the anode 12 to the cathode 13 through the separator 19 when the battery is discharged and migrate from the cathode 13 to the anode 12 through the separator 19 when the battery is charged.

The separator 19 may comprises perfluorinated ionomers, partially fluorinated polymers, and non-fluorinated hydrocarbons. The separator 19 may be made of or comprises Nafion®, Flemion®, NEOSEPTA-F®, or Gore Select®.

The separator 19 is disposed in a center in a vertical direction (a stacking direction of a plurality of layers 10) of the frame 11. The separator 19 is coupled and fixed to the frame 11.

The anode current collector 14 is disposed at one side of the frame 11. The anode current collector 14, the frame 11 and the separator 19 defines a space where the anode 12 is accommodated. The anode current collector 14 is electrically connected to the anode 12, such that electrons migrate therebetween to cause current to flow when the battery is charged and discharged. The anode current collector 14 acts as a negative-electrode from which electrons are released when the battery is discharged, and acts as a positive-electrode into which electrons migrate when the battery is charged.

The anode current collector 14 is made of a metal with high electrical conductivity, such as copper or aluminum. The anode current collector 14 may be formed as a flexible thin film or as a rigid plate. The anode current collector 14 is formed in a rectangular plate shape such that a portion thereof protrudes horizontally beyond a side of the frame. The portion of the anode current collector 14 protrudes horizontally beyond the side of the fame.

The bipolar plate 17 may be disposed between the anode current collector 14 and the anode 12. The bipolar plate 17 may be made of a material such as graphite, carbon, and carbon plastic, and has high electrical conductivity and high acid resistance. The bipolar plate 17 is electrically connected to the anode current collector 14 and the anode 12 to allow electrons to migrate between the anode current collector 14 and the anode 12 but prevents the anode current collector 14 from being oxidized by the electrolyte of the anode 12. The bipolar plate 17 may be formed by coating the material such as graphite, carbon, and carbon plastic onto the anode current collector 14.

The cathode current collector 15 is disposed at one side of the frame 11 such that the space where the cathode 13 is accommodated is defined by the cathode current collector 15, the frame 11 and the separator 19. The cathode current collector 15 is electrically connected to the cathode 13, such that electrons migrate therebetween to cause current to flow when the battery is charged and discharged. The cathode current collector 15 acts as a positive-electrode into which electrons migrate when the battery is discharged, and acts as a negative-electrode from which electrons are released when the battery is charged.

The cathode current collector 15 is made of a metal with high electrical conductivity, for example, copper or aluminum. The cathode current collector 15 may be formed as a flexible thin film or as a rigid plate. The cathode current collector 15 is formed in a rectangular plate shape such that a portion thereof protrudes horizontally beyond a side of the frame. The portion of the cathode current collector 15 protrudes horizontally beyond the side of the fame.

The bipolar plate 17 may be disposed between the cathode current collector 15 and the cathode 13. The bipolar plate 17 is made of a material such as graphite, carbon, and carbon plastic, and has high electrical conductivity and high acid resistance. The bipolar plate 17 is electrically connected to the cathode current collector 15 and the cathode 13 to allow electrons to migrate between the cathode current collector 15 and the cathode 13, but to prevent the cathode current collector 15 from being oxidized by the electrolyte of the cathode 13. The bipolar plate 17 may be formed by coating the material such as graphite, carbon, and carbon plastic on the cathode current collector 15.

Referring to FIG. 2, the portion of each of the anode current collector 14 and the cathode current collector 15 protrudes beyond the side of the frame 11. In this regard, the portion of the anode current collector 14 and the portion of the cathode current collector 15 protrude in opposite directions to each other. That is, a portion of the anode current collector 14 protrudes beyond one side of the frame 11, while the portion of the cathode current collector 15 protrudes beyond an opposite side of the frame 11 to one side thereof beyond the anode current collector 14 protrudes.

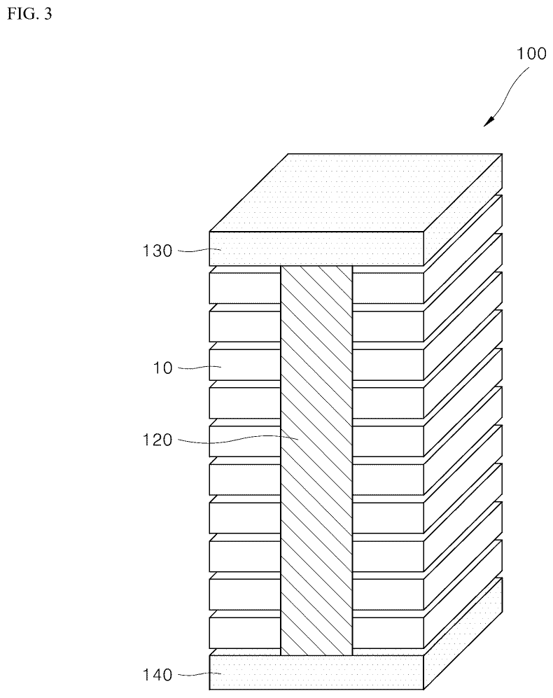

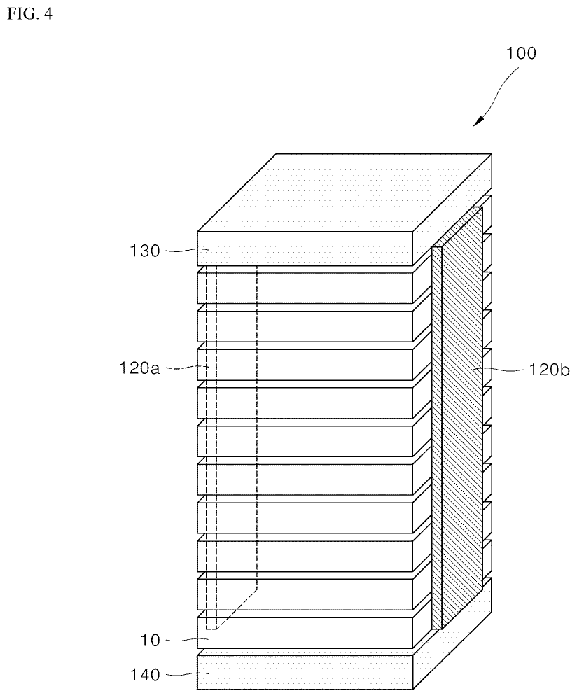

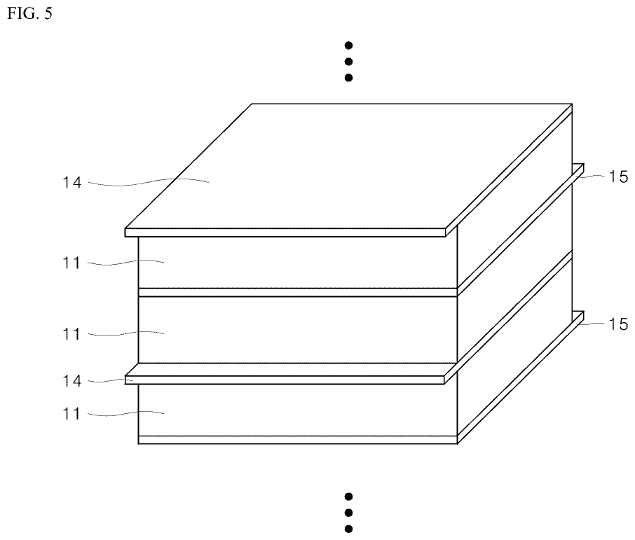

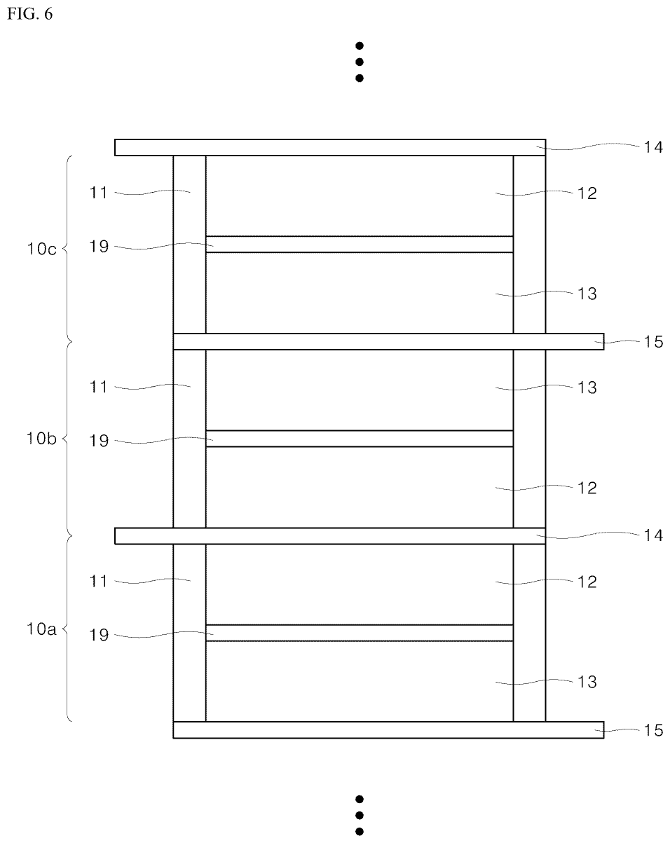

FIG. 3 and FIG. 4 are perspective views of a secondary battery module according to an embodiment of the present disclosure, FIG. 5 is a partial perspective view of a secondary battery module according to an embodiment of the present disclosure, and FIG. 6 is a partial cross-sectional view of a secondary battery module according to an embodiment of the present disclosure.

A secondary battery module 100 according to an embodiment of the present disclosure comprises a plurality of layers 10 in which an oxidation-reduction reaction occurs and which are stacked vertically, a pair of busbars 120 electrically connecting the plurality of layers 10 to each other, an upper end plate 130 disposed on the plurality of layers 10 and a lower end plate 140 disposed beneath the plurality of layers 10.

The plurality of layers 10 are stacked vertically (in a height direction or the gravity direction). The secondary battery module 100 according to the present disclosure may relatively well withstand a pressure applied thereto in the vertical direction (the stacking direction) but is vulnerable to a pressure applied thereto in a horizontal direction perpendicular to the stacking direction. Thus, the secondary battery module 100 is disposed such that the stacking direction of the plurality of layers 10 is a vertical direction. Furthermore, when the plurality of layers 10 are arranged in the vertical direction, it is easy to withdraw each secondary battery module 100 in maintenance. A stack of the plurality of layers 10 stacked in the vertical direction may have a rectangular parallelepiped shape with a large height.

The upper end plate 130 and the lower end plate 140 are respectively disposed at both opposing ends in the vertical direction of the stack of the plurality of layers 10. The upper end plate 130 is disposed on the stack of the plurality of layers 10, and the lower end plate 140 is disposed beneath the stack of the plurality of layers 10. The pair of busbars 120 are respectively disposed at both opposing side surfaces of the stack of the plurality of layers 10.

One anode current collector 14 is disposed between adjacent ones of the plurality of layers 10, and then one cathode current collector 15 is disposed between next adjacent ones of the plurality of layers 10. That is, one anode current collector 14 is disposed between a pair of adjacent anodes 12, and one cathode current collector 15 is disposed between a pair of adjacent cathodes 13.

Referring to FIG. 6, the anode 12 of one layer 10 of the plurality of layers 10 is stacked beneath the anode 12 of another adjacent layer 10. The cathode 13 of the another adjacent layer 10 is stacked beneath the cathode 13 of still another adjacent layer 10 to the another adjacent layer 10. Therefore, adjacent ones of the plurality of layers 10 share one anode current collector 14 or the cathode current collector 15. One anode current collector 14 among the plurality of anode current collectors 14 is disposed between the pair of anodes 12 adjacent to each other. One cathode current collector 15 among the plurality of cathode current collectors 15 is disposed between a pair of cathodes 13 adjacent to each other.

Referring to FIG. 6, the plurality of layers 10 are vertically arranged so that the anode 12 of a first battery cell 10a is adjacent to the anode 12 of a second battery cell 10b while the anode current collector 14 is disposed therebetween, the cathode 13 of the second battery cell 10b is adjacent to the cathode 13 of the third battery cell 10c while the cathode current collector 15 is disposed therebetween.

Referring to FIG. 5, each of the plurality of anode current collectors 14 and the plurality of cathode current collectors 15 partially protrudes beyond each of both opposing sides of the frames of the plurality of layers 10. In other words, a portion of each of the plurality of anode current collectors 14 protrudes beyond one side of the frame 11 of each of the plurality of layers 10, while a portion of each of the plurality of cathode current collectors 15 protrudes beyond an opposite side to the one side of the frame 11 of each of the plurality of layers 10 (beyond which the portion of each of the plurality of anode current collectors 14 protrudes).

Each of the pair of busbars 120 extends in an elongate manner in the vertical direction (in the stacking direction of the plurality of layers 10) and has a shape of an elongate bar or plate extending in one direction. Each of the pair of busbars 120 extends vertically along a longitudinal direction thereof.

A height of the busbar 120 is larger than a height of the stack of the plurality of layers 10. A vertical level of a top of each of the pair of busbars 120 is higher than a vertical level of a top of the stack of the plurality of layers 10, while a vertical level of a bottom each of the pair of busbars 120 is lower than a vertical level of a bottom of the stack of the plurality of layers 10. An upper end of each of the pair of busbars 120 may be in contact with the upper end plate 130, and a lower end thereof may be in contact with the lower end plate 140. An insulator may be disposed between the pair of busbars 120 and the upper end plate 130 and/or between the pair of busbars 120 and the lower end plate 140.

The pair of busbars 120 are respectively disposed at both opposing side surface of the stack of the plurality of layers 10 and electrically connect the plurality of layers 10 to each other. In this embodiment, the busbar 120 connects the plurality of layers 10 in parallel to each other. An insulator may be disposed between each of the pair of busbars 120 and each of both opposing side surfaces of the stack of the plurality of layers 10.

The pair of busbars 120 are respectively disposed at both opposing side surfaces of the sack of the plurality of layers 10. One busbar 120 of the pair of busbars 120 is disposed at one side surface of the stack of the plurality of layers 10, and the other busbar 120 thereof is disposed at the other side surface of the stack of the plurality of layers 10 opposite to the side surface (on which one busbar 120 is disposed).

The pair of busbars 120 may fasten the plurality of layers 10 to each other. The busbars 120 may be coupled to the upper end plate 130 and the lower end plate 140 to fasten the plurality of layers 10 to each other.

The pair of busbars 120 comprises a first busbar 120a that electrically connects the plurality of anode current collectors 14 to each other and a second busbar 120b that electrically connects the plurality of cathode current collectors 15 to each other. The first busbar 120a is disposed at one side surface of the stack of the plurality of layers 10, and the second busbar 120b is disposed at the opposite side to the side surface of the stack of the plurality of layers 10 where the first busbar 120a is disposed.

The portion of each of the plurality of anode current collectors 14 protruding beyond the side of the frame of each of the plurality of layers 10 is bent so as to be connected to the first busbar 120a. A portion of each of the plurality of cathode current collectors 15 protruding beyond the side of the frame of each of the plurality of layers 10 is bent so as to be connected to the second busbar 120b.

The upper end plate 130 and the lower end plate 140 are disposed at both opposing ends in the stacking direction, that is, the top and the bottom of the stack of the layers 10, respectively. Each of the upper end plate 130 and the lower end plate 140 may have a rectangular parallelepiped shape with a small height. According to an embodiment, each of the upper end plate 130 and the lower end plate 140 may have various three-dimensional shapes in which upper and lower surfaces are parallel to each other. Each of the upper end plate 130 and the lower end plate 140 may be made of a high-strength inorganic compound material (such as cement), or a high-strength organic compound material (such as engineering plastic), or may be made of a mixture of an insulator coated metal and the cement.

The upper end plate 130 and the lower end plate 140 may respectively protect the top and the bottom of the stack of the plurality of layers 10. The upper end plate 130 and the lower end plate 140 together with fastening means (fastener) may press the stack of the plurality of layers 10 to fasten the stack. In this embodiment, the fastening means may be embodied as the busbar 120. According to an embodiment, the fastening means may be a band or tie that surrounds and fastens the upper end plate 130, the plurality of layers 10, and the lower end plate 140 to each other.

The upper end plate 130 and/or the lower end plate 140 may protrude horizontally beyond the side of the stack of the plurality of layers 10. Since the plurality of secondary battery modules 100 are arranged densely in the horizontal direction, respective adjacent upper end plates 130 and/or lower end plates 140 of adjacent ones of the secondary battery module 100 are arranged horizontally and are in close contact with each other such that the horizontally adjacent ones of the plurality of layers 10 are not in close contact with each other. In the plurality of secondary battery modules 100 arranged densely in the horizontal direction, horizontally adjacent upper end plates 130 and/or lower end plates 140 may be in close contact with each other such that two layers of the plurality of layers 10 adjacent to each other in the horizontal direction may be spaced apart from each other.

The secondary battery module 100 has a substantially rectangular shape that extends in an elongate manner in the vertical direction. The stacking direction of the layers 10 in the secondary battery module 100 is the height direction thereof.

FIG. 7 is a partial cross-sectional view of a secondary battery module according to another embodiment of the present disclosure.

According to another embodiment of the present disclosure, the anode 12 of one layer 10 of the plurality of layers 10 is stacked beneath the cathode 13 of another adjacent layer 10. The current collectors 14 and 15 are disposed between the anode 12 and the cathode 13 which are adjacent to each other in the vertical direction.

Referring to FIG. 7, the plurality of layers 10 are stacked such that the anode 12 of the first battery cell 10a is adjacent to the cathode 13 of the second battery cell 10b while the current collectors 14, 15 are disposed therebetween, and the anode 12 of the second battery cell 10b is adjacent to the cathode 13 of the third battery cell 10c while the current collectors 14, 15 are disposed therebetween. In this case, the plurality of layers 10 are connected in series.

FIG. 8 is a view illustrating a schematic configuration of a secondary battery according to an embodiment of the present disclosure.

A secondary battery 200 according to an embodiment of the present disclosure comprises a plurality of secondary battery modules 100, a container 210 having an accommodation space S formed therein to accommodate therein the plurality of secondary battery modules 100, and an air-conditioning unit 220 disposed on the plurality of secondary battery modules 100 to cool, heat, or ventilate the plurality of secondary battery modules 100.

The secondary battery 200 refers to a battery pack or an energy storage system (ESS) including the plurality of secondary battery modules 100.

The plurality of secondary battery modules 100 are densely arranged in a horizontal direction so as to sufficiently and horizontally fill the accommodation space S of the container 210. According to an embodiment, a horizontal arrangement of the plurality of secondary battery modules 100 densely arranged in the horizontal direction may be stacked in a vertical direction on another horizontal arrangement of the plurality of secondary battery modules 100 densely arranged in the horizontal direction. In addition, the plurality of secondary battery modules 100 disposed in the horizontal direction may be accommodated in a housing (or a case), and a plurality of housings (or cases) may be stacked vertically. In addition, a plate for supporting each horizontal arrangement of the plurality of secondary battery modules 100 may be provided so as to be disposed between two horizontal arrangements of the plurality of secondary battery modules 100 stacked vertically. Each vertical arraignment of the plurality of secondary battery modules 100 may slide in a horizontal direction individually so as to be accommodated into or withdrawn from a vessel container 9 or the housing (or case).

The container 210 is a standardized container. The secondary battery 200 comprises the container 210 standardized in appearance so as to contain therein the secondary battery modules 100 and is able to be transported, installed, and collected by standardized equipment or transportation means. The container 210 may be disposed on the ground, may be disposed underground, or may be carried on a ship or a vehicle. The container 210 has the accommodation space S defined therein, and the plurality of secondary battery modules 100 are received in the accommodation space S. The plurality of secondary battery modules 100 may be configured such that a height thereof is smaller than a height of the accommodation space S of the container 210, and thus, the air-conditioning unit 220 may be disposed on the plurality of secondary battery modules 100.

The air-conditioning unit 220 is disposed on the plurality of battery modules 100. The air-conditioning unit 220 may be disposed on the accommodation space S of the container 210, or may be disposed out of the container 210 and on top thereof. The air-conditioning unit 220 comprises an upper cover 221 and a bottom cover 222 spaced apart from each other in a vertical direction to constitute an air-conditioning space H. The air-conditioning space H may prevent heat of the upper cover 221 heated by solar radiation from being transferred to the plurality of battery modules 100. The air-conditioning unit 220 cools or heats the plurality of battery modules 100 via flow of fluid or gas (air) in the air-conditioning unit 220. In addition, the air-conditioning unit 220 may discharge the air heated by the plurality of battery modules 100 to the outside.

According to an embodiment, an insulating material for blocking heat transfer may be provided in the air-conditioning space H. According to an embodiment, the insulating material may be disposed in the inner accommodation space S of the container 210. That is, the insulation material may be disposed at an inner side surface, an inner top surface, and an inner bottom surface of the container 210. According to an embodiment, each of the upper end plate 130 and the lower end plate 140 respectively disposed at the upper end and the lower end of each of the plurality of battery modules 100 may be made of a material having a low thermal conductivity (e.g. ceramic, concrete, fiber-reinforced concrete, composite material, etc.).

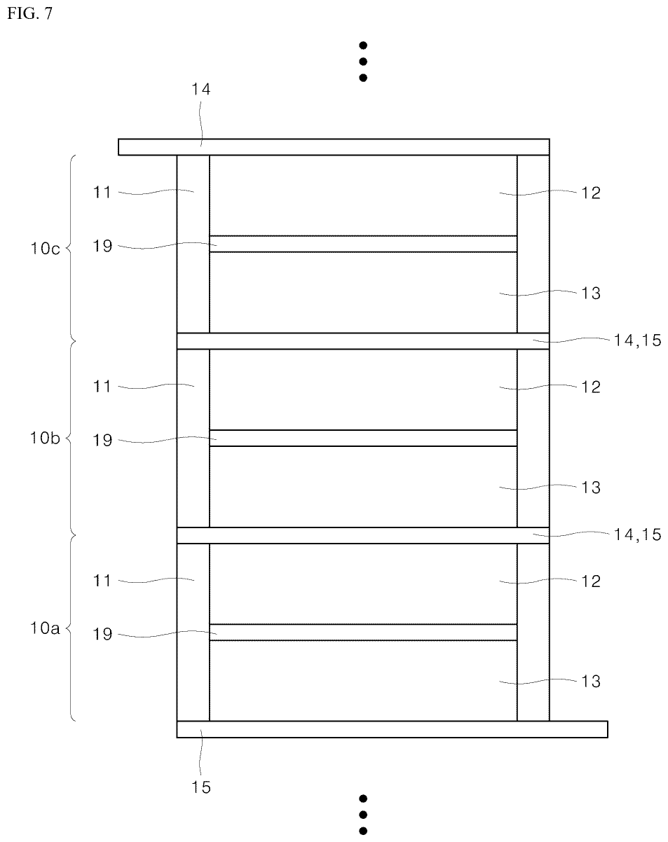

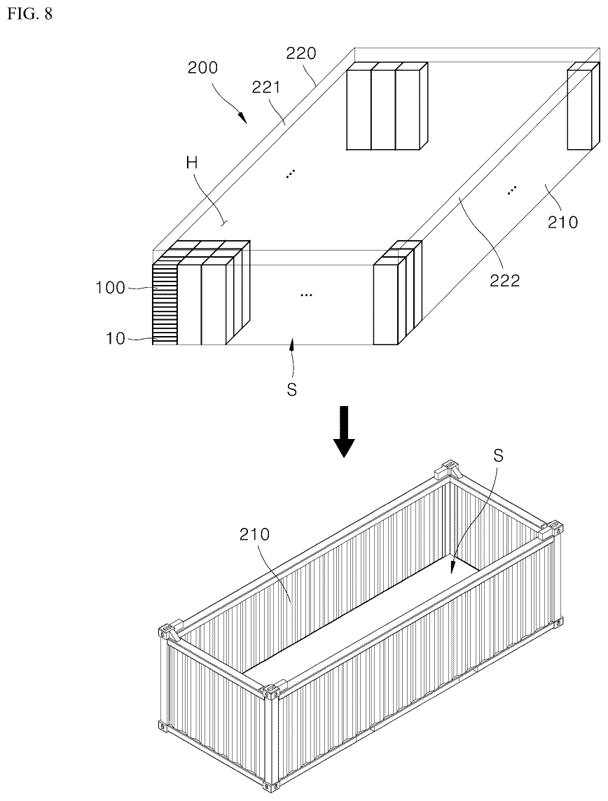

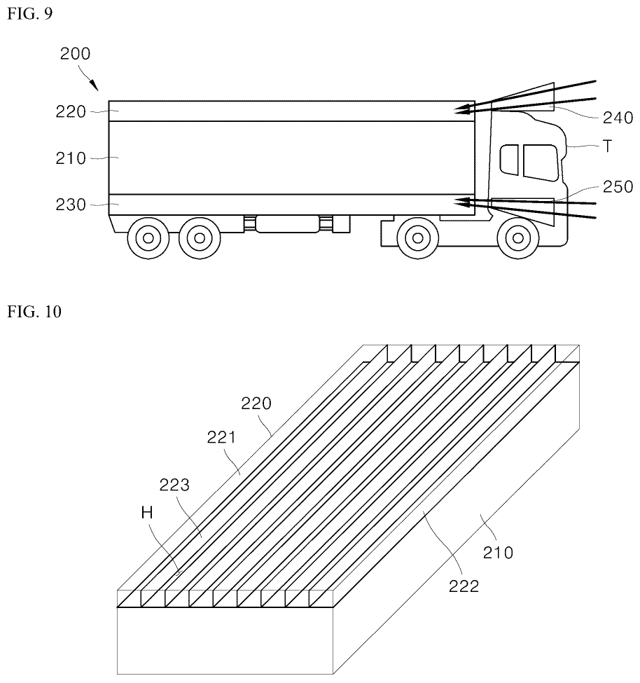

FIG. 9 is an example view showing that a secondary battery according to an embodiment of the present disclosure is transported by transportation means.

The transportation means T may be a variety of transportation means such as a vehicle or a ship. In the present embodiment, the transportation means T is the vehicle for carrying the container. The secondary battery 200 according to the present embodiment comprises an air guide 240 for guiding air to the air-conditioning unit 220 when the transportation means T moves.

The air guide 240 is disposed in the transportation means T, the container 210, or the air-conditioning unit 220 to guide air to the air-conditioning unit 220 when the transportation means T moves, thereby cooling the plurality of secondary battery modules 100.

The secondary battery 200 according to the present embodiment may further comprises an auxiliary air-conditioning unit 230 capable of cooling, heating, or ventilating the container 210, and an auxiliary air guide 250 for guiding air to the auxiliary air-conditioning unit 230.

The auxiliary air-conditioning unit 230 may be disposed at a side surface or a bottom surface of the container 210. In this embodiment, the auxiliary air-conditioning unit 230 is disposed beneath the container 210 to support the container 210 thereon. In this case, the auxiliary air-conditioning unit 230 may have a shock-absorbing member for mitigating vibration or impact. The shock-absorbing member may serve as a thermal insulator. According to an embodiment, the auxiliary air-conditioning unit 230 may discharge heat generated from the plurality of secondary battery modules 100 or air heated by the plurality of secondary battery modules 100. In this case, the auxiliary air guide 250 may serve as an outlet through which the heated air flowing through the auxiliary air-conditioning unit 230 is discharged.

The air guide 240 and the auxiliary air guide 250 may be disposed at an upper surface, a side surface, or a bottom surface of the container 210 or the transportation means T. The air-conditioning unit 220 or the auxiliary air-conditioning unit 230 may comprise a fin to increase cooling efficiency by air supplied along the air guide 240 or the auxiliary air guide 250. In addition, the air-conditioning unit 220 or the auxiliary air-conditioning unit 230 may comprise an air-conditioner, a radiator, a water-based cooling device, a heat pump, a thermoelectric element, or a Joule heating element to cool or heat the container 210. A bus bar, a battery management system (BMS), and/or an energy management system (EMS) may be disposed in the air-conditioning unit 220 or the auxiliary air-conditioning unit 230.

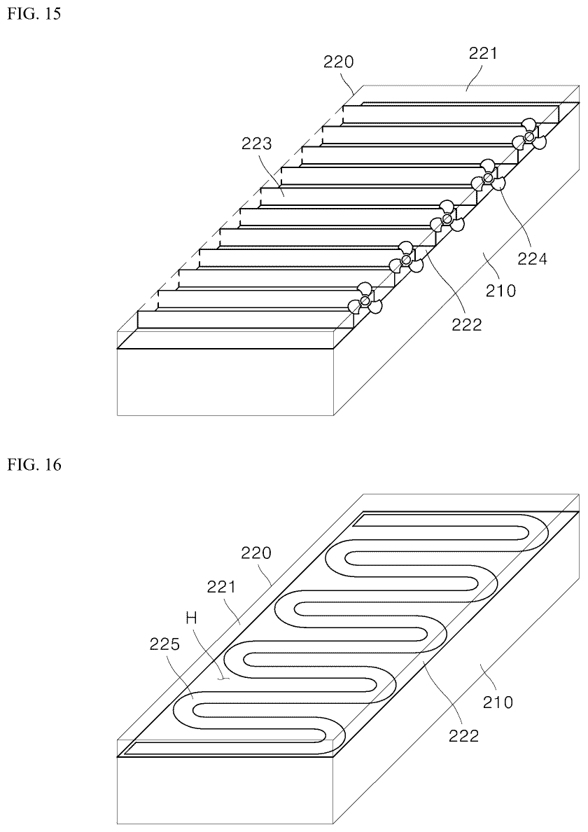

FIGS. 10 to 16 are views illustrating various examples of an air-conditioning unit of a secondary battery according to an embodiment of the present disclosure.

The air-conditioning unit 220 according to an embodiment of the present disclosure comprises a plurality of cooling fins 223 protruding in a vertical direction. The cooling fins 223 increase heat discharge efficiency and induce a cooling due to natural convection to cool the air-conditioning unit 220, the container 210, and/or the plurality of secondary battery modules 100. The plurality of cooling fins 223 may be arranged to be spaced apart from each other such that a flow path through which air flows is defined between adjacent ones thereof.

A relation between a spacing between the adjacent ones of the cooling fins 223 and a flow of air therein may be defined as a Reynolds number. When the spacing between the cooling fins 223 is equal to or smaller than a predetermined value, power for inducing the flow of the fluid is large. On the other hand, when the spacing between the cooling fins 223 is too large, uniform cooling may not be achieved, and heat exchange efficiency may be deteriorated. Therefore, the relation between the spacing between the cooling fins 223 and a speed of the fluid may be optimized based on the Reynolds number.

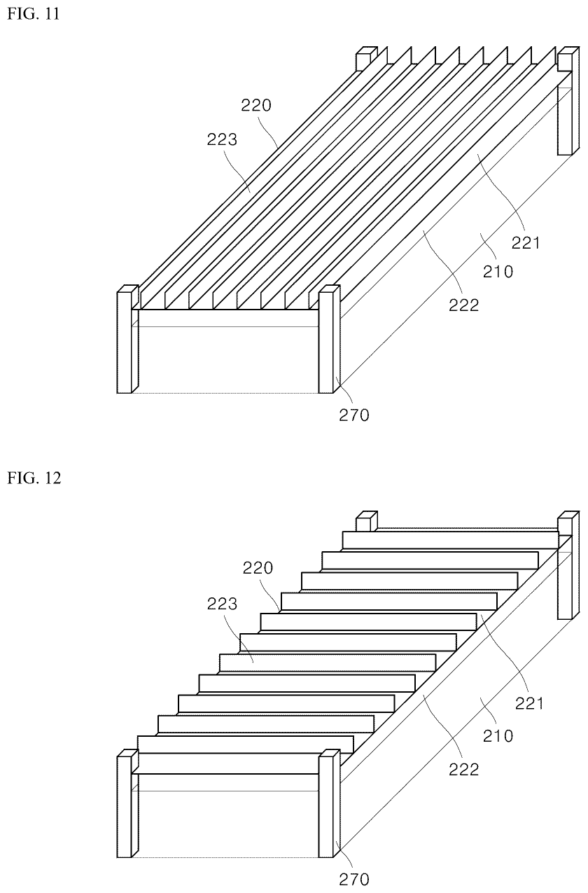

Referring to FIG. 10, the cooling fin 223 may protrude upwardly from the bottom cover 222 or may protrude downwardly from the upper cover 221. That is, the cooling fin 223 may be disposed between the upper cover 221 and the bottom cover 222, that is, in the air-conditioning space H. Referring to FIGS. 11 and 12, the cooling fin 223 may protrude upwardly from the upper cover 221.

A longitudinal direction in which the cooling fin 223 may extend may be a longitudinal direction of the container 220 (see FIGS. 10 and 11), or may be a direction perpendicular to the longitudinal direction of the container (see FIG. 12), depending on an installation direction of the secondary battery 200, the movement direction of the transportation means or a flow direction of air.

According to an embodiment, the cooling fin 223 may serve as a bus bar for electrically connecting at least some of the plurality of battery modules 100 to each other.

Referring to FIGS. 11 and 12, the secondary battery 200 may comprise a supporter 270 protruding upwardly. The supporter 270 is disposed at each corner of the air-conditioning unit 220 to support the container or a service module disposed above the secondary battery 200. The upper end of the supporter 270 protrudes upwardly beyond the cooling fin 223 protruding upwardly from the air-conditioning cover 221.

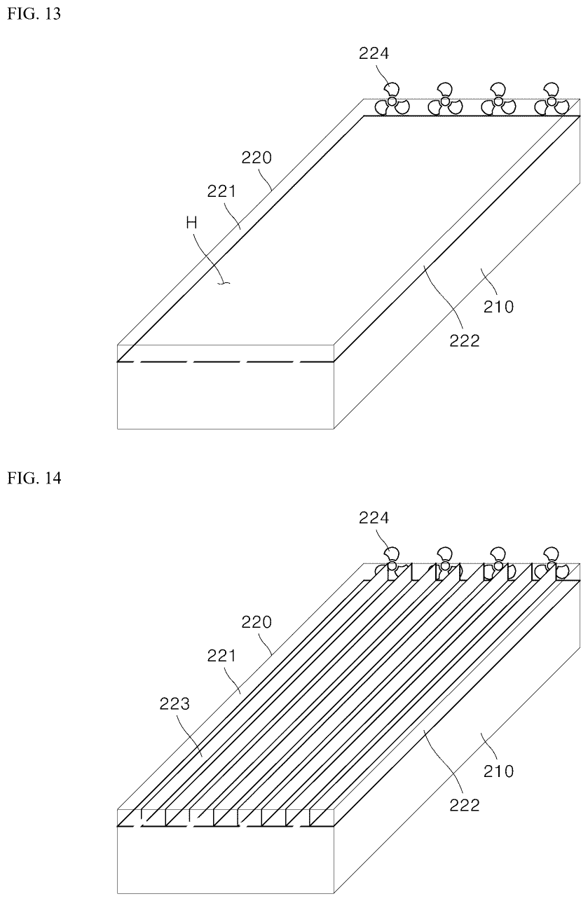

Referring to FIGS. 13 to 15, the air-conditioning unit 220 comprises a blower 224 for flowing the air. The blower 224 may flow the air toward the air-conditioning space H and/or the cooling fin 223 to increase cooling efficiency.

When the secondary battery 200 is installed on a place which is stationary, there is no air flow, such that cooling efficiency may be reduced. For this reason, the blower 224 may be provided. The blower 224 may be removable from the secondary battery and may be removed therefrom when the secondary battery 200 is transferred by the vehicle.

The blower 224 may flow the air into between the upper cover 221 and the bottom cover 222, that is, into the air-conditioning space H. The blower 224 may flow the air in the longitudinal direction of the cooling fin 223.

The blower 224 may receive electricity from the plurality of battery modules 100 or the transportation means T. The solar power generation means may be separately disposed at the blower 224 and may generate electricity from the solar energy. The plurality of battery modules 100 may be cooled or heated using an air-conditioner, a radiator, a water-based cooling device, a heat pump, a thermoelectric device, a Joule heating device, and the like which use the electricity in addition to the blower 224. The electricity used for the cooling and heating may be supplied to the air-conditioner, the radiator, a water-based cooling device, the heat pump, the thermoelectric device, the Joule heating device, and the like from the plurality of battery modules 100. Alternatively, the solar power generation means may be separately provided on the air-conditioner, the radiator, the water-based cooling device, the heat pump, the thermoelectric device, a Joule heating device, and the like which in turn may receive the electricity from the solar power generation means.

Referring to FIG. 16, the air-conditioning unit 220 comprises a cooling flow path 225 through which refrigerant (including cooling water) for cooling or heating the battery modules flows. The cooling flow path 225 may be disposed between the upper cover 221 and the bottom cover 222, that is, in the air-conditioning space H.

The cooling flow path 225 may be connected to the air-conditioner, the radiator, the water-based cooling device, or the heat pump so that the refrigerant cooled or heated by the air-conditioner, the radiator, the water-based cooling device, or the heat pump flows in the cooling flow path 225. The refrigerant flowing through the cooling flow path 225 cools or heats the air-conditioning unit 220, the container 210, and/or the plurality of secondary battery modules 100.

The refrigerant flowing in the cooling flow path 225 may comprise water, oil, gas, or the like having a heat capacity equal to or greater than a predetermined level. The refrigerant flowing through the cooling flow path 225 may employ the collected rain water or seawater. The refrigerant flowing through the cooling flow path 225 may be injected into the container 210 to cool the container 210.

The cooling flow path 225 may extend to a side surface or a bottom surface of the container 210. The cooling flow path 225 may cool a bus bar, a battery management system (BMS), or an energy management system (EMS).

A waterproof material for preventing leakage or intrusion of the refrigerant flowing through the cooling flow path 225 may be disposed in the air-conditioning unit 220 and/or the container 210. That is, when the cooling flow path 225 is utilized, each of the battery module 100, the air-conditioning unit 220, and the container 210 may be thermally insulated or electrically insulated from the cooling flow path 225 or may be prevented from contacting refrigerant from the cooling flow path 225 for safety.

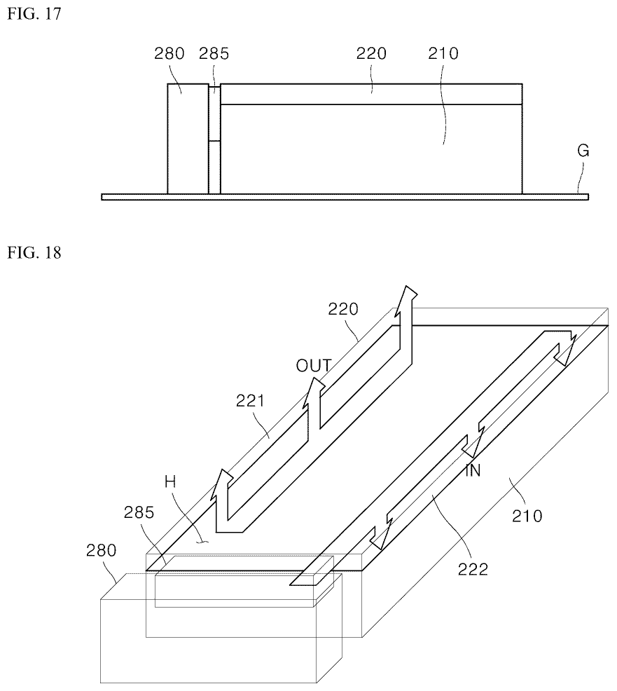

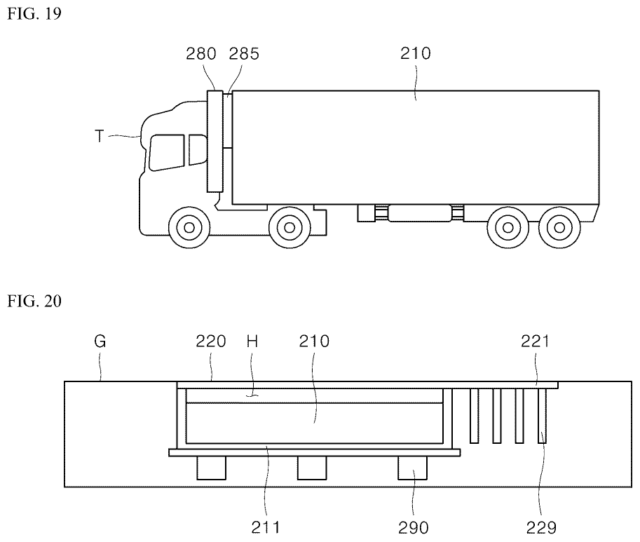

FIGS. 17 and 18 are views illustrating a schematic configuration of a secondary battery according to another embodiment of the present disclosure, and FIG. 19 is an example view illustrating that a secondary battery according to another embodiment of the present disclosure is transported by transportation means.

The secondary battery 200 according to another embodiment of the present disclosure may comprise a service module 280 connected to the container 210 for performing control and/or thermal management thereof. The service module 280 is disposed separately from the container 210 and is connected to the container 210 via a connector 285.

The service module 280 may comprise a battery management system (BMS) for reducing a difference between voltages of the plurality of battery modules 100 and/or an energy management system (EMS) for controlling power and performing communication with an external device and managing a temperature. In addition, the service module 280 may comprise an air-conditioning device for cooling, heating, or ventilating the air-conditioning unit 220, the container 210, and/or the plurality of secondary battery modules 100. The air-conditioning device may be embodied as a blower such as a fan, an air-conditioner, a radiator, a water-based cooling device, a heat pump, a thermoelectric device, or a Joule heating device.

The connector 285 may comprise a power cable through which electricity passes and a signal cable through which a signal passes. In addition, the connector 285 may comprise a flow path through which a fluid or gas (air) cooled or heated in the air-conditioning unit flows.

Referring to FIG. 18, the air cooled in the air-conditioning device of the service module 280 flows to the air-conditioning unit 220 through the connector 285. The cooled air flowing into the air-conditioning unit 220 flows downwardly and cools the plurality of secondary battery modules 100. That is, the air cooled in the air-conditioning device of the service module 280 flows into the plurality of secondary battery modules 100 through the connector 285.

The air heated by the plurality of secondary battery modules 100 is discharged to the outside through the air-conditioning unit 220. The air heated by the plurality of secondary battery modules 100 may be discharged over the air-conditioning unit 220. According to an embodiment, the air heated by the plurality of secondary battery modules 100 may flow to the service module 280 through the connector 285. According to an embodiment, the air heated by the plurality of secondary battery modules 100 may be discharged through the auxiliary air-conditioning unit 230 (see FIG. 9) disposed beneath the container 210.

When the container 210 is installed, the service module 280 may be disposed on the ground G. The service module 289 may be carried in the transportation means T when the container 210 is transported thereby. Referring to FIG. 19, when the transportation means T is a container carrying vehicle, the service module 280 may be disposed in a cap of the vehicle.

FIG. 20 is a view illustrating a schematic configuration of a secondary battery according to still another embodiment of the present disclosure.

When the container 210 is installed underground, the upper cover 221 of the air-conditioning unit 220 according to still another embodiment of the present disclosure is spaced apart from the container 210 so as to cover a top of the container 210. The upper cover 221 may have a rib or truss structure, an I-beam or H-beam-shaped structure to increase rigidity to protect the container 210, and this structure may serve as a fin for heat dissipation.

The upper cover 221 of the air-conditioning unit 220 may extend in the horizontal direction so as to be connected to a geothermal heat exchanger 229. The geothermal heat exchanger 229 may cool or heat the upper cover 221 by exchanging heat with underground soil or groundwater. The geothermal heat exchanger 229 may act as an electrical ground. The geothermal heat exchanger 229 prevents the upper cover 221 from being excessively heated by solar radiation in the daytime. In addition, the geothermal heat exchanger 229 heats the upper cover 221 at night to prevent excessive cooling of the plurality of battery modules 100.

The cooling flow path 225 through which underground water flows may be disposed in the air-conditioning space H. In this case, the air-conditioning unit 220 may cool or heat the container 210 using the groundwater, and a waterproof material for preventing leakage or intrusion of the underground water flowing through the cooling flow path 225 may be disposed on the air-conditioning unit 220 and/or the container 210.

A thermal and electrical insulating member 211 for thermal insulating, electrical insulating, and/or shock-absorbing may be disposed at an inner side surface and an inner bottom surface of the container 210. A base 290 may be disposed beneath the container 210. The base 290 may support the container 210 thereon, and may cool or heat the container 210 by exchanging heat with underground soil or groundwater as the geothermal heat exchanger 229 may act. Further, the base may act as an electrical ground.

The preferred embodiments of the present disclosure have been shown and described above. However, the present disclosure is not limited to the specific embodiments as described above. Various modifications may be made thereto by those skilled in the art without departing from the technical idea of the present disclosure as claimed in the patent claims. These modifications should not be understood individually based on the technical idea or perspective of the present disclosure.

1. A secondary battery comprising:
a plurality of secondary battery modules;
a container accommodating the plurality of secondary battery modules therein; and
an air-conditioning unit disposed on the plurality of secondary battery modules to cool, heat, or ventilate the plurality of secondary battery modules.

2. The secondary battery of claim 1, wherein the air-conditioning unit comprises an upper cover and a bottom cover spaced apart from each other in a vertical direction so as to define an air-conditioning space therebetween.

3. The secondary battery of claim 2, wherein the air-conditioning unit further comprises a thermal insulator disposed in the air-conditioning space.

4. The secondary battery of claim 2, wherein the air-conditioning unit further comprises a plurality of cooling fins disposed in the air-conditioning space.

5. The secondary battery of claim 1, wherein the container comprises a thermal insulator disposed at one or both of an inner side surface and an inner bottom surface of the container.

6. The secondary battery of claim 1, further comprising an air guide to guide air to the air-conditioning unit.

7. The secondary battery of claim 1, further comprising an auxiliary air-conditioning unit disposed at a side surface of the container and/or beneath the container to cool, heat, or ventilate the container.

8. The secondary battery of claim 1, wherein each of the plurality of secondary battery modules comprises:
a stack of a plurality of layers vertically stacked, wherein a redox reaction occurs in each of the plurality of layers; and
an upper end plate disposed on the stack of the plurality of layers; and
a lower end plate disposed beneath the stack of the plurality of layers,
wherein each of the upper end plate and the lower end plate is made of a material having a low thermal conductivity.

9. The secondary battery of claim 8, wherein each of the upper end plate and the lower end plate is made of ceramic or fiber-reinforced concrete.

10. The secondary battery of claim 1, wherein the plurality of secondary battery modules are arranged densely in a horizontal direction to form a horizontal arrangement,
wherein a plurality of horizontal arrangements are stacked vertically.

11. The secondary battery of claim 1, wherein the air-conditioning unit comprises a plurality of cooling fins protruding upwardly.

12. The secondary battery of claim 1, wherein the air-conditioning unit comprises a blower to flow air.

13. The secondary battery of claim 1, wherein the air-conditioning unit comprises a cooling flow path through which refrigerant flows.

14. The secondary battery of claim 13, wherein each of the plurality of secondary battery modules comprises:
a stack of a plurality of layers vertically stacked, wherein a redox reaction occurs in each of the plurality of layers; and
a pair of bus bars electrically connecting the plurality of layers to each other,
wherein the cooling flow path is configured to cool one or both of the bus bars.

15. The secondary battery of claim 1, further comprising a service module connected to the air-conditioning unit to control the plurality of secondary battery modules and manage a temperature of the plurality of secondary battery modules.

16. The secondary battery of claim 15, further comprising a connector connecting the air-conditioning unit and the service module to each other,
wherein the connector comprises a flow path through which air cooled or heated in the service module flows.

17. The secondary battery of claim 15, wherein air cooled in the service module flows to the plurality of secondary battery modules through the air-conditioning unit.

18. The secondary battery of claim 15, wherein air heated by the plurality of secondary battery modules is discharged to an outside through the air-conditioning unit.

19. The secondary battery of claim 1, further comprising a geothermal heat exchanger configured to exchange heat with underground soil or groundwater,
wherein the air-conditioning unit is connected to the geothermal heat exchanger.
